(19) United States
(12) Patent Application Publication
(10) Pub. No.: US 2026/0127611 A1
(43) Pub. Date: May 7, 2026

(54) DYNAMIC MODIFICATION OF VIRTUAL IDENTIFIERS BASED ON MACHINE LEARNING

(71) Applicant: Capital One Services, LLC, McLean, VA (US)

(72) Inventors: Lawrence Hutchison DOUGLAS, JR., McLean, VA (US); Jeffrey RULE, Chevy Chase, MD (US); Jackson MACOMBER, Henrico, VA (US)

(21) Appl. No.: 18/938,692

(22) Filed: Nov. 6, 2024

(51) Int. Cl. G06Q 20/40; G06Q 20/34

(52) U.S. Cl. CPC G06Q 20/4016; G06Q 20/351; G06Q 20/4014

(57) ABSTRACT

In some implementations, an identifier manager may receive an indication of the virtual identifier that is linked to a permanent identifier. The identifier manager may receive, from a data storage, a data structure encoding at least one event associated with the virtual identifier.

The identifier manager may provide the data structure to a machine learning model in order to a receive a score associated with the at least one event. The identifier manager may map the score to an instruction to modify the virtual identifier. The identifier manager may link a modified virtual identifier to the permanent identifier and unlink the virtual identifier from the permanent identifier. The identifier manager may transmit, to one or more devices using the virtual identifier, an indication of the modified virtual identifier.

### BACKGROUND

To improve security in a computerized system, virtual identifiers may be used in place of permanent identifiers. For example, a virtual card number (VCN) may be used in place of a payment account number (PAN). Tokenizing the PAN into the VCN improves security because the VCN may be replaced, if compromised, more easily than the PAN.

### SUMMARY

Some implementations described herein relate to a system for dynamically modifying a virtual identifier. The system may include one or more memories and one or more processors communicatively coupled to the one or more memories. The one or more processors may be configured to receive an indication of the virtual identifier that is linked to a permanent identifier. The one or more processors may be configured to receive a data structure encoding at least one event associated with the virtual identifier. The one or more processors may be configured to provide the data structure to a machine learning model in order to a receive a score associated with the at least one event. The one or more processors may be configured to map the score to an instruction to modify the virtual identifier and to a restriction to apply. The one or more processors may be configured to link a modified virtual identifier to the permanent identifier and unlink the virtual identifier from the permanent identifier. The one or more processors may be configured to transmit, to one or more devices using the virtual identifier, an indication of the modified virtual identifier. The one or more processors may be configured to apply the restriction to the modified virtual identifier.

Some implementations described herein relate to a method of dynamically modifying a virtual identifier. The method may include receiving, at an identifier manager, an indication of the virtual identifier that is linked to a permanent identifier. The method may include receiving, from a data storage, a data structure encoding at least one event associated with the virtual identifier. The method may include providing the data structure to a machine learning model in order to a receive a score associated with the at least one event. The method may include mapping, by the identifier manager, the score to an instruction to modify the virtual identifier. The method may include linking, by the identifier manager, a modified virtual identifier to the permanent identifier and unlinking the virtual identifier from the permanent identifier. The method may include transmitting, from the identifier manager and to one or more devices using the virtual identifier, an indication of the modified virtual identifier.

Some implementations described herein relate to a non-transitory computer-readable medium that stores a set of instructions for receiving a dynamic modification of a virtual identifier. The set of instructions, when executed by one or more processors of a device, may cause the device to transmit a request to authorize an event associated with the virtual identifier, wherein the event is recurring. The set of instructions, when executed by one or more processors of the device, may cause the device to receive, in response to the request, an indication that the virtual identifier is being modified. The set of instructions, when executed by one or more processors of the device, may cause the device to receive an indication of a modified virtual identifier. The set of instructions, when executed by one or more processors of the device, may cause the device to store the modified virtual identifier and discard the virtual identifier. The set of instructions, when executed by one or more processors of the device, may cause the device to transmit a new request using the modified virtual identifier. The set of instructions, when executed by one or more processors of the device, may cause the device to receive a confirmation of the new request using the modified virtual identifier.

### BRIEF DESCRIPTION OF THE DRAWINGS

FIGS. 1A-1E are diagrams of an example implementation relating to dynamic modification of virtual identifiers based on machine learning, in accordance with some embodiments of the present disclosure.

FIGS. 2A-2B are diagrams illustrating an example of training and using a machine learning model in connection with systems and/or methods described herein, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to dynamic modification of virtual identifiers based on machine learning, in accordance with some embodiments of the present disclosure.

FIG. 6 is a flowchart of an example process relating to receiving a dynamic modification of a virtual identifier, in accordance with some embodiments of the present disclosure.

### DETAILED DESCRIPTION

The following detailed description of example implementations refers to the accompanying drawings. The same reference numbers in different drawings may identify the same or similar elements.

To improve security in a computerized system, virtual identifiers may be used in place of permanent identifiers. For example, a VCN may be used in place of a PAN. Tokenizing the PAN into the VCN improves security because the VCN may be replaced, if compromised, more easily than the PAN. As a result, computer resources are conserved.

However, risk of compromise may increase the longer and/or more often that the VCN is used. Generally, a set of rules may set a hard expiry for the VCN (e.g., after a particular number of uses and/or on a particular datetime). The set of rules may waste computer resources, however, when the VCN is replaced prematurely. Additionally, the set of rules may waste computer resources when the VCN is compromised before being due for replacement.

Some implementations described herein enable a machine learning model to determine when to swap a first virtual identifier for a second virtual identifier. The machine learning model may be a generalized model for virtual identifiers or may be specific to the first virtual identifier. As a result, the machine learning model conserves computer resources that would otherwise have been wasted on prematurely replacing the first virtual identifier. Additionally, the machine learning model reduces risk of compromise for the first virtual identifier, which conserves computer resources that otherwise would have been wasted on undoing fraudulent events (e.g., transactions) performed using the first virtual identifier.

In some implementations, the machine learning model may additionally recommend a restriction to add to the second virtual identifier. For example, a cap, a category restriction, a geographic restriction, and/or a merchant restriction may be added to the second virtual identifier to further improve security after the second virtual identifier is swapped with the first virtual identifier. As a result, the machine learning model reduces risk of compromise for the second virtual identifier, which conserves computer resources that otherwise would have been wasted on undoing fraudulent events (e.g., transactions) performed using the second virtual identifier.

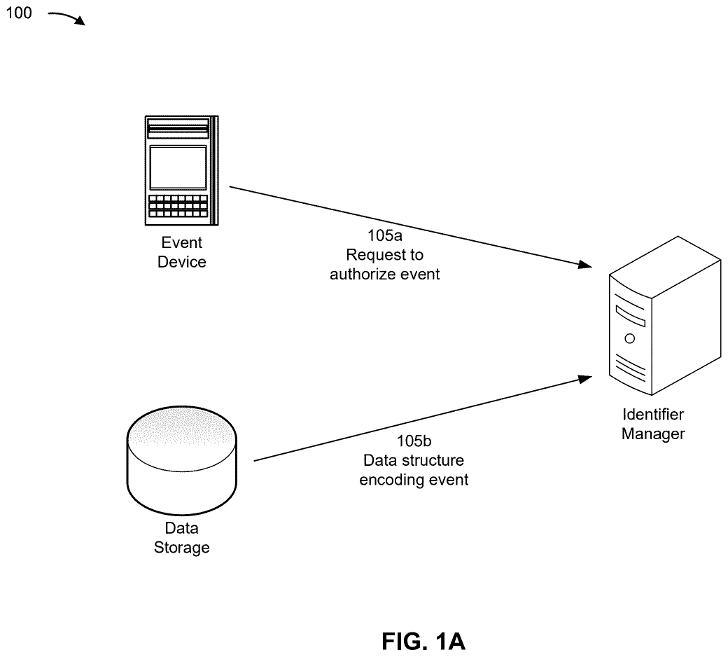

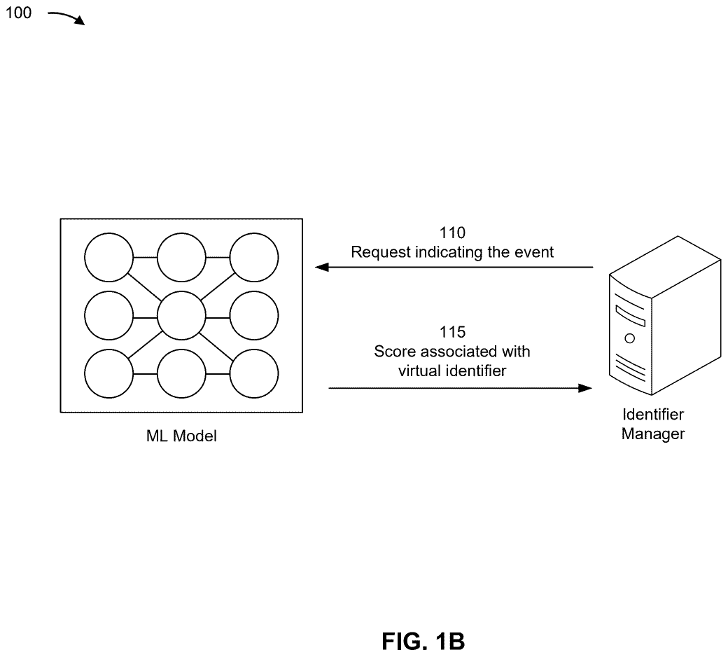

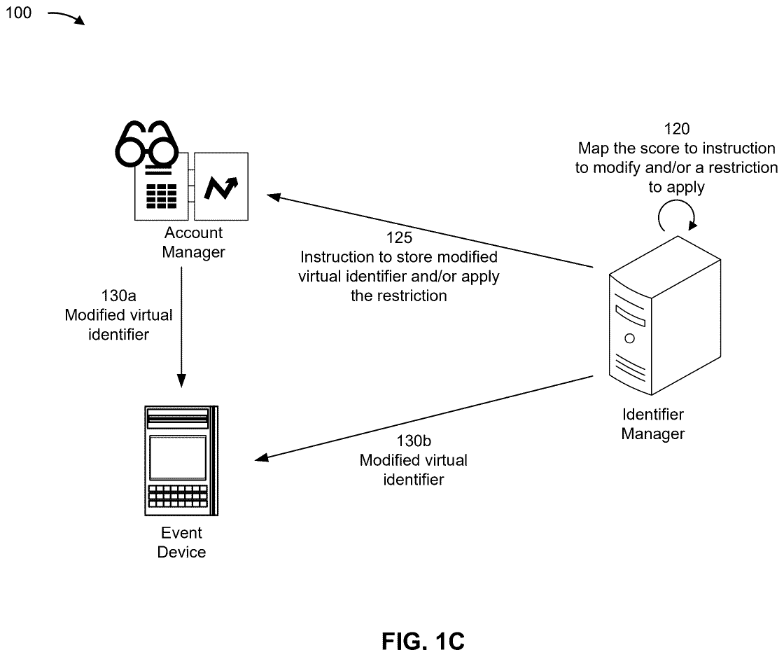

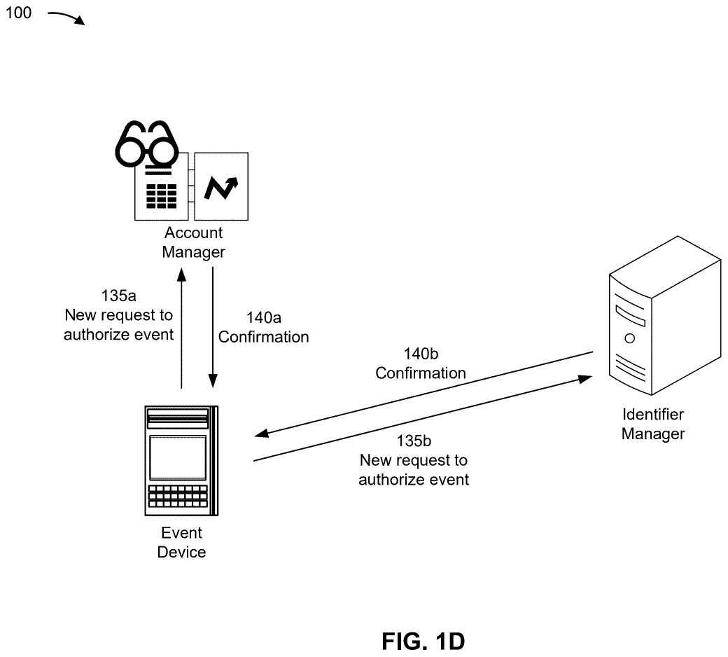

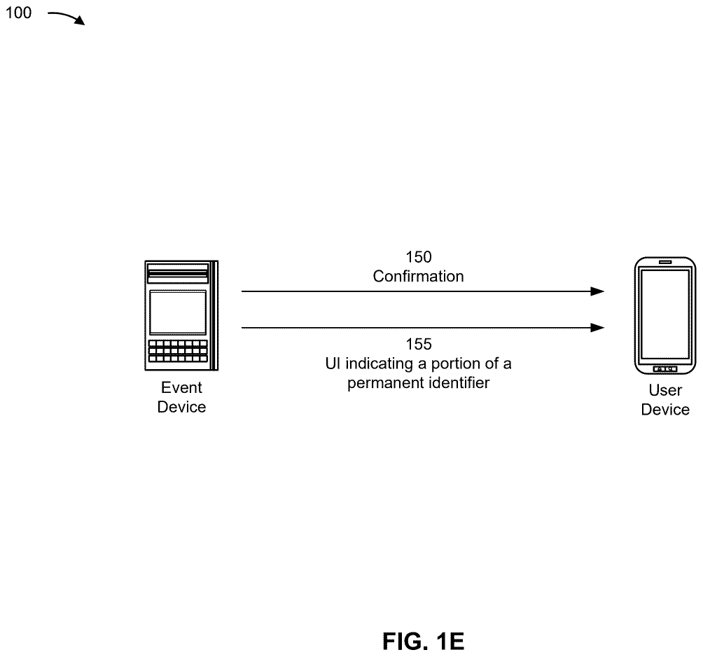

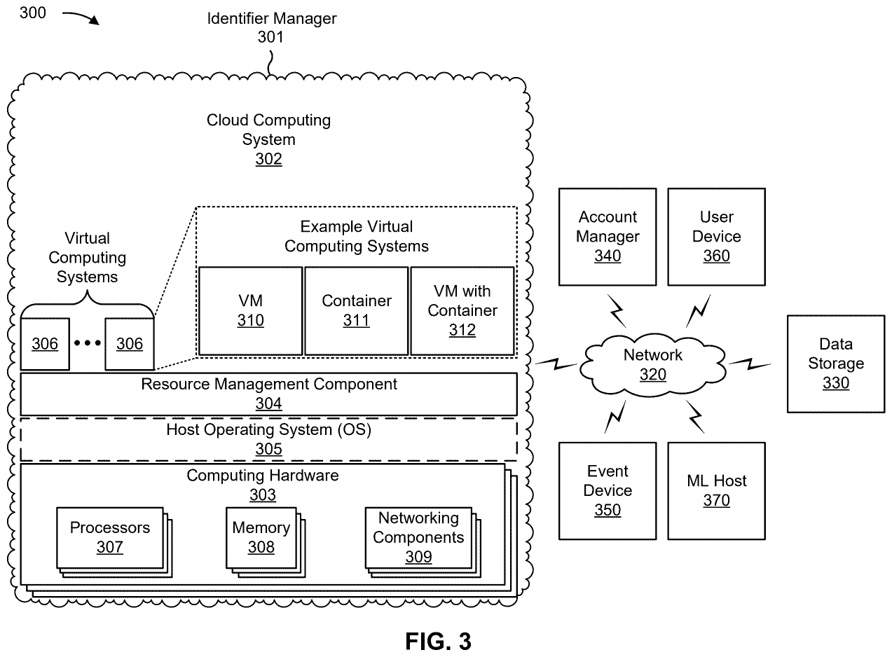

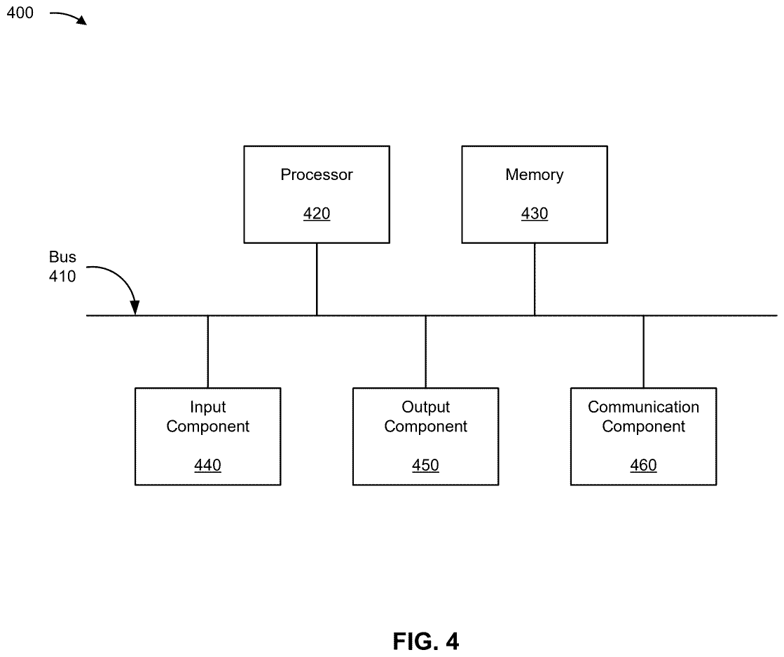

FIGS. 1A-1E are diagrams of an example 100 associated with dynamic modification of virtual identifiers based on machine learning. As shown in FIGS. 1A-1E, example 100 includes an event device, a data storage, an identifier manager, a machine learning (ML) model (e.g., provided by an ML host), an account manager, and a user device. These devices are described in more detail in connection with FIGS. 3 and 4.

The identifier manager may receive an indication of a virtual identifier that is linked to a permanent identifier. For example, the virtual identifier may be a VCN or another type of tokenized value, and the permanent identifier may be a PAN or another type of secret value. The identifier manager may generate the virtual identifier (e.g., using a pseudo-random number generator or another type of algorithm) and may associate the virtual identifier with the permanent identifier. Therefore, the identifier manager may receive the indication from an application executed by the identifier manager. Alternatively, the identifier manager may receive the indication from a separate device or system (e.g., the account manager, as described herein).

As shown in FIG. 1A and by reference number 105a, the event device may transmit, and the identifier manager may receive, a request to authorize an event (e.g., at least one event) associated with the virtual identifier. The event may be a transaction or another type of event. The request may include a data structure (e.g., a comma separated values (CSV) file or another type of delimiter separated values (DSV) file, an extensible markup language (XML) file, and/or a JavaScript® object notation (JSON) file, among other examples) encoding the event associated with the virtual identifier. In some implementations, the request may include an encrypted indication of the virtual identifier. For example, the request may include a token, and the token may include an encrypted version of the virtual identifier.

Although the example 100 depicts the request being transmitted directly from the event device to the identifier manager, other examples may include one or more devices and/or systems between the event device and the identifier manager. For example, a processing device may route the request from the event device to the identifier manager. Additionally, or alternatively, a payment network may transfer the request from the event device (and/or the processing device) to the identifier manager. Additionally, or alternatively, the account manager may forward the request to the identifier manager (e.g., directly or by decoding information from the request and reencoding the information in a new message).

Therefore, the identifier manager may apply the ML model (e.g., as described in connection with FIG. 1B) while processing the event. Alternatively, the identifier manager may apply the ML model periodically (e.g., according to a default schedule or a custom schedule) and/or in response to a request from an administrator. Accordingly, as shown by reference number 105b, the data storage may transmit, and the identifier manager may receive, a data structure encoding the event associated with the virtual identifier. The event may be a previous transaction or another type of historical event. The data structure may therefore encode the historical event (e.g., an event that was approved) associated with the virtual identifier.

In some implementations, the data storage may push events to the identifier manager (e.g., periodically or as new events associated with the virtual identifier are received and approved). Additionally, or alternatively, the identifier manager may pull events from the data storage (e.g., periodically or in response to a request from an administrator). For example, the identifier manager may transmit (and the data storage may receive) a request for events associated with the virtual identifier, and the data storage may transmit (and the identifier manager may receive) the data structure (encoding the event) in response to the request. The request may include a hypertext transfer protocol (HTTP) request, a file transfer protocol (FTP) request, and/or an application programming interface (API) call. The request may include the virtual identifier (or at least an encrypted version of the virtual identifier) in a header and/or as an argument. Therefore, the data storage may retrieve all events (e.g., using a structured query language (SQL) query or another type of query) that are associated with the virtual identifier in response to the request and may encode results (of the query) in the data structure that is returned to the identifier manager.

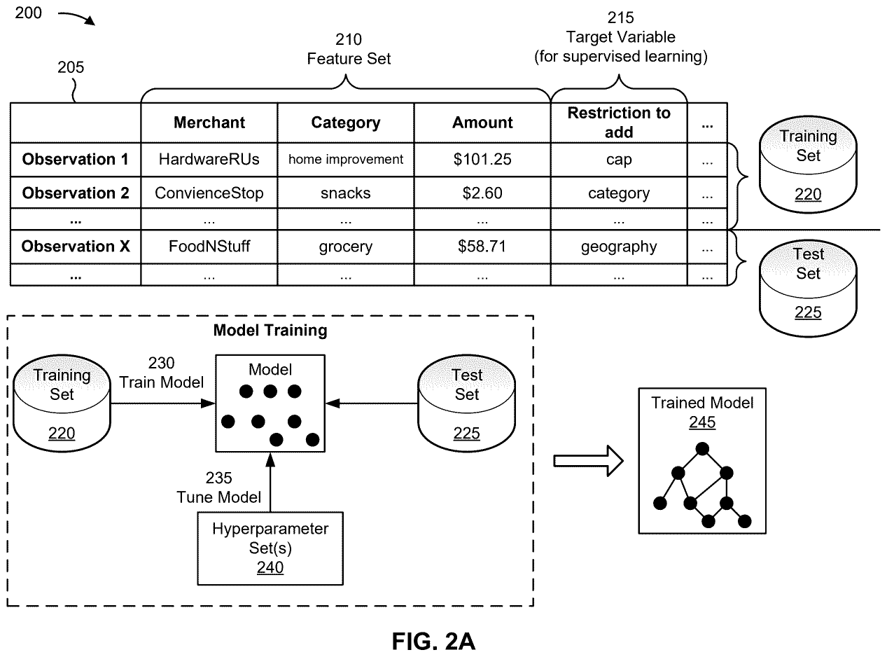

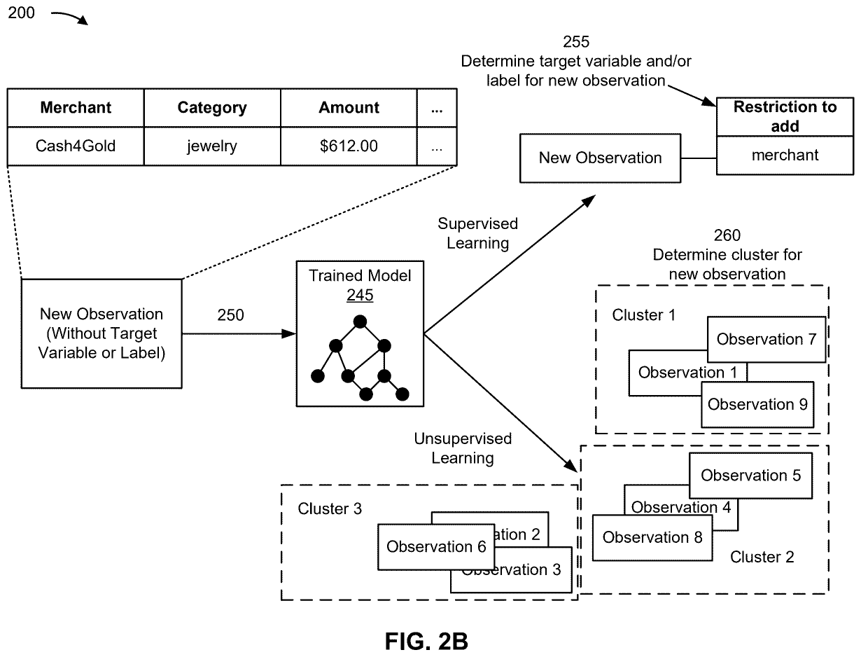

As shown in FIG. 1B and by reference number 110, the identifier manager may provide the data structure to the ML model. For example, the identifier manager may transmit, and the ML host associated with the ML model may receive, a request indicating the event. The ML model may be trained (e.g., by the ML host and/or a device at least partially separate from the ML host) to generate a score associated with the event (represented by the data structure) and/or with the virtual identifier. In some implementations, the ML model may be general (e.g., trained on information associated with multiple virtual identifiers and/or applied to events associated with multiple virtual identifiers). For example, the score may represent a level of risk associated with the event. Alternatively, the ML model may be unique to the virtual identifier (e.g., trained on information unique to the virtual identifier and/or applied only to events associated with the virtual identifier). For example, the score may represent a cumulative level of risk associated with the virtual identifier. Additionally, or alternatively, the ML model may be trained and used as described in connection with FIGS. 2A-2B.

As shown by reference number 115, the ML model may output the score (associated with the event and/or the virtual identifier). For example, the identifier manager may receive the score (e.g., from the ML host in response to the request from the identifier manager). As shown in FIG. 1C and by reference number 120, the identifier manager may map the score to an instruction to modify the virtual identifier. In one example, the identifier manager may determine that the score satisfies a swapping threshold, and the swapping threshold may be associated with (e.g., stored with a link to) the instruction to modify the virtual identifier. The swapping threshold may be a default value or a custom value. The custom value may be input by an administrator (and stored at the identifier manager) or may be adjusted by the ML model. For example, the swapping threshold may be set based on a median score output by the ML model, an average score output by the ML model, or another type of formula that uses scores output by the ML model to adjust the swapping threshold.

In another example, the identifier manager may receive the instruction from a table (or another type of relational data structure or a NoSQL database) that stores a set of instructions in association with a set of possible scores. The set of possible scores may include different ranges (e.g., stored in rows of the table) that are associated with different actions. For example, a range associated with low risk may be associated with no action (e.g., an instruction to refrain from modifying the virtual identifier) while a range associated with high risk may be associated with the instruction to modify the virtual identifier. The table may be a default table or a custom table. The custom table may be input by an administrator (and stored at the identifier manager) or may be adjusted by the ML model. For example, different possible scores in the table may be set based on a lowest score output by the ML model, a median score output by the ML model, a highest score output by the ML mode, and/or another type of formula that uses scores output by the ML model to adjust the set of possible scores in the table.

Because the identifier manager uses the ML model to determine to swap out the virtual identifier, the identifier manager conserves computer resources that would otherwise have been wasted on prematurely replacing the virtual identifier. Additionally, risk of compromise for the virtual identifier is reduced, which conserves computer resources that otherwise would have been wasted on undoing fraudulent events (e.g., transactions) performed using the virtual identifier.

In some implementations, the identifier manager may transmit, and the event device may receive, an indication that the virtual identifier is being modified. For example, the event device may store the virtual identifier (or at least an encrypted version of the virtual identifier, such as a token that includes the encrypted version of the virtual identifier) for reuse (e.g., the event being a recurring event). In other words, the event device may be authorized to perform repeat events using the virtual identifier. Therefore, the identifier manager may inform the event device that the virtual identifier is being swapped out.

In some implementations, and as further shown by reference number 120, the identifier manager may further map the score to a restriction to apply. In one example, the identifier manager may determine the restriction using a table (or another type of relational data structure or a NoSQL database) that stores a set of restrictions in association with a set of possible scores. The set of possible scores may include different ranges (e.g., stored in rows of the table) that are associated with different restrictions. For example, a range associated with low risk may be associated with a cap (e.g., a limit to apply) while a range associated with high risk may be associated with a geographic restriction (e.g., a proximity limit to apply). As described above, the table may be a default table or a custom table. In another example, the ML model may output an indication of the restriction, as described in connection with FIGS. 2A-2B.

The identifier manager may generate a modified virtual identifier and may link the modified virtual identifier to the permanent identifier. For example, the identifier manager may generate the modified virtual identifier using a pseudo-random number generator or another type of algorithm. In some implementations, and as shown by reference number 125, the identifier manager may transmit, and the account manager may receive, an instruction to store the modified virtual identifier in association with the permanent identifier. Therefore, the account manager may, in response to the instruction, authorize future requests associated with the modified virtual identifier (e.g., by detokenizing the modified virtual identifier to the permanent identifier).

In some implementations, and as further shown by reference number 125, the identifier manager may transmit, and the account manager may receive, an instruction to apply the restriction to the modified virtual identifier. For example, the account manager may, in response to the instruction, only authorize future requests associated with the modified virtual identifier that satisfy the restriction.

Additionally, in some implementations, the identifier manager may unlink the virtual identifier from the permanent identifier. For example, the identifier manager may transmit, and the account manager may receive, an instruction to disassociate the virtual identifier from the permanent identifier. In some implementations, the account manager may discard the virtual identifier in response to the instruction. Alternatively, the account manager may retain the virtual identifier (in association with the permanent identifier) while refraining from authorizing any future requests associated with the virtual identifier.

Although the example 100 depicts the identifier manager as separate from the account manager, other examples may include the account manager as at least partially integrated (e.g., virtually, logically, and/or physically) with the identifier manager. Therefore, operations described herein as performed by the account manager may be performed by the identifier manager.

As further shown in FIG. 1C, the event device may receive an indication of the modified virtual identifier (e.g., a token that includes an encrypted version of the modified virtual identifier). In some implementations, and as shown by reference number 130a, the account manager may transmit, and the event device may receive, the indication of the modified virtual identifier. For example, the account manager may transmit, and the event device may receive, the indication of the modified virtual identifier in response to the request from the event device (e.g., as described in connection with FIG. 1A). In some implementations, the account manager (and/or the identifier manager) may deny the request from the event device (using the virtual identifier), such that the event device attempts the event again using the modified virtual identifier (e.g., as described in connection with FIG. 1D). Alternatively, the account manager (and/or the identifier manager) may approve the request from the event device (using the virtual identifier), and thus the event device receives the (indication of the) modified virtual identifier to use in future requests.

Alternatively, and as shown by reference number 130b, the identifier manager may transmit, and the event device may receive, the indication of the modified virtual identifier. For example, the identifier manager may transmit the indication of the modified virtual identifier to devices (e.g., one or more devices) using the virtual identifier, which includes the event device. Therefore, any devices using the virtual identifier are informed that the virtual identifier is being replaced with the modified virtual identifier. In some implementations, the identifier manager may identify the devices using the virtual identifier from a list of devices associated with the permanent identifier. Additionally, or alternatively, the account manager may transmit, and the identifier manager may receive, an indication of the devices using the virtual identifier.

In response to receiving the indication of the modified virtual identifier, the event device may store the modified virtual identifier. For example, the event device may store a token that includes an encrypted version of the modified virtual identifier. Therefore, the event device may use the modified virtual identifier for future requests (e.g., recurring events). Additionally, in some implementations, the event device may discard the virtual identifier. For example, the event device may discard a token that includes an encrypted version of the virtual identifier. Therefore, the event device may refrain from using the virtual identifier for future requests (e.g., recurring events) because the account manager (and/or the identifier manager) will reject future requests associated with the virtual identifier.

As described above, the account manager (and/or the identifier manager) may approve the request from the event device (described in connection with FIG. 1A). Accordingly, the account manager (and/or the identifier manager) may transmit, and the event device may receive, a confirmation of the event in response to the request. Alternatively, as described above, the account manager (and/or the identifier manager) may deny the request from the event device (described in connection with FIG. 1A). Accordingly, the account manager (and/or the identifier manager) may transmit, and the event device may receive, a rejection of the event in response to the request. As shown in FIG. 1D, the event device may thus resubmit the event for approval. For example, as shown by reference number 135a, the event device may transmit, and the account manager may receive, a new request (to authorize the event) using the modified virtual identifier. Alternatively, as shown by reference number 135b, the event device may transmit, and the identifier manager may receive, the new request (to authorize the event) using the modified virtual identifier. The new request may include a data structure (e.g., a CSV file or another type of DSV file, an XML file, and/or a JSON file, among other examples) encoding the event associated with the modified virtual identifier. In some implementations, the new request may include an encrypted indication of the modified virtual identifier. For example, the new request may include a token, and the token may include an encrypted version of the modified virtual identifier. The event device may transmit the new request in response to the rejection of the event (and/or the indication of the modified virtual identifier).

Although the example 100 depicts the new request being transmitted directly from the event device to the identifier manager and/or the account manager, other examples may include one or more additional devices and/or systems. For example, a processing device may route the new request from the event device to the identifier manager and/or the account manager.

Additionally, or alternatively, a payment network may transfer the new request from the event device (and/or the processing device) to the identifier manager and/or the account manager. In some implementations, the account manager may forward the new request to the identifier manager (e.g., directly or by decoding information from the request and reencoding the information in a new message).

The account manager (and/or the identifier manager) may approve the new request from the event device. Accordingly, the account manager may transmit, and the event device may receive, a confirmation of the event in response to the new request, as shown by reference number 140a. Alternatively, as shown by reference number 140b, the identifier manager may transmit, and the event device may receive, a confirmation of the event in response to the new request. In some implementations, as shown in FIG. 1E and by reference number 150, the event device may transmit, and the user device may receive, a confirmation of the event (in response to the confirmation from the account manager and/or the identifier manager). The confirmation transmitted to the user device may be forwarded directly or may be a new message encoding information that was decoded by the event device from the confirmation received from the account manager and/or the identifier manager. Additionally, or alternatively, the event device may output the confirmation of the event to a user (e.g., using an output component of the event device).

Even though the event device was using the virtual identifier (and subsequently uses the modified virtual identifier), the event device may output a portion of the permanent identifier in order to improve a user's experience. For example, the event device may transmit, and the user device may receive, instructions for a user interface (UI) indicating the portion of the permanent identifier (associated with the virtual identifier and the modified virtual identifier), as shown by reference number 155. The portion of the permanent identifier may include, among other examples, a final four digits of the permanent identifier. Additionally, or alternatively, the event device may output the portion of the permanent identifier directly to a user (e.g., using an output component of the event device).

By using techniques as described in connection with FIGS. 1A-1E, the ML model determines when to swap the virtual identifier for the modified virtual identifier. As a result, the ML model conserves computer resources that would otherwise have been wasted on prematurely replacing the virtual identifier. Additionally, the ML model reduces risk of compromise for the virtual identifier, which conserves computer resources that otherwise would have been wasted on undoing fraudulent events (e.g., transactions) performed using the virtual identifier. The ML model may additionally suggest the restriction to apply. As a result, the ML model reduces risk of compromise for the modified virtual identifier, which conserves computer resources that otherwise would have been wasted on undoing fraudulent events (e.g., transactions) performed using the modified virtual identifier.

As indicated above, FIGS. 1A-1E are provided as an example. Other examples may differ from what is described with regard to FIGS. 1A-1E.

FIGS. 2A and 2B are diagrams illustrating an example 200 of training and using a machine learning model in connection with dynamic modification of virtual identifiers based on machine learning. The machine learning model training described herein may be performed using a machine learning system. The machine learning system may include or may be included in a computing device, a server, a cloud computing environment, or the like, such as an identifier manager and/or an ML host described in more detail below.

As shown by reference number 205, a machine learning model may be trained using a set of observations. The set of observations may be obtained and/or input from training data (e.g., historical data), such as data gathered during one or more processes described herein. For example, the set of observations may include data gathered from an event device, as described elsewhere herein. In some implementations, the machine learning system may receive the set of observations (e.g., as input) from a data storage.

As shown by reference number 210, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from the data storage. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of a merchant, a second feature of a category, a third feature of an amount, and so on. As shown, for a first observation, the first feature may have a value of “HardwareRUs,” the second feature may have a value of “home improvement,” the third feature may have a value of $101.25, and so on. These features and feature values are provided as examples, and may differ in other examples. For example, the feature set may include one or more of the following features: a location (e.g., associated with the merchant and/or the observation), a proximity (e.g., between the merchant and a user), and/or an authorization type (e.g., swipe, tap, insert, or virtual, among other examples), among other examples. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 215, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 200, the target variable is a restriction to add, which has a value of “cap” for the first observation.

The target variable described is provided as an example, and other examples may differ from what is described above. For example, the target variable may include a score (e.g., representing a risk associated with the observation or representing a cumulative risk associated with an account) in addition to, or in lieu of, a restriction to add.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique.

When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that may include a first subset of observations, of the set of observations, and a test set 225 that may include a second subset of observations of the set of observations.

The training set 220 may be used to train (e.g., fit or tune) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm may include a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used and/or based on randomly generating hyperparameter values). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups and/or based on randomly selecting a number of groups) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, or closest to a desired threshold) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 245 to be used to analyze new observations, as described below in connection with FIG. 3.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 245.

FIG. 2B is a diagram illustrating applying the trained machine learning model 245 to a new observation. As shown by reference number 250, the machine learning system may receive a new observation (or a set of new observations), and may input the new observation to the machine learning model 245. As shown, the new observation may include a first feature of “Cash4Gold,” a second feature of “jewelry,” a third feature of $612.00, and so on, as an example. The machine learning system may apply the trained machine learning model 245 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 245 may predict a value of “merchant” for the target variable of a restriction to add for the new observation, as shown by reference number 255. Based on this prediction (e.g., based on the value having a particular label or classification or based on the value satisfying or failing to satisfy a threshold), the machine learning system may provide a recommendation and/or output for determination of a recommendation, such as an indication of the merchant restriction to add. Additionally, or alternatively, the machine learning system may perform an automated action and/or may cause an automated action to be performed (e.g., by instructing another device to perform the automated action), such as transmitting an instruction to apply the merchant restriction. As another example, if the machine learning system were to predict a value of “cap” for the target variable of a restriction to add, then the machine learning system may provide a different recommendation (e.g., an indication of the cap) and/or may perform or cause performance of a different automated action (e.g., transmitting an instruction to apply the cap). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In some implementations, the trained machine learning model 245 may classify (e.g., cluster) the new observation in a cluster, as shown by reference number 260. The observations within a cluster may have a threshold degree of similarity. As an example, if the machine learning system classifies the new observation in a first cluster (e.g., associated with higher risk), then the machine learning system may provide a first recommendation, such as a merchant restriction to add. Additionally, or alternatively, the machine learning system may perform a first automated action and/or may cause a first automated action to be performed (e.g., by instructing another device to perform the automated action) based on classifying the new observation in the first cluster, such as transmitting an instruction to apply the merchant restriction. As another example, if the machine learning system were to classify the new observation in a second cluster (e.g., associated with lower risk), then the machine learning system may provide a second (e.g., different) recommendation (e.g., a cap to add) and/or may perform or cause performance of a second (e.g., different) automated action, such as transmitting an instruction to apply the cap. The recommendations, actions, and clusters described above are provided as examples, and other examples may differ from what is described above.

In this way, the machine learning system may apply a rigorous and automated process to restricting (and swapping) virtual identifiers. The machine learning system may enable flexible swapping (and restricting) of virtual identifiers, which conserves computer resources wasted on swapping (and restricting) virtual identifiers too early (e.g., low risk virtual identifiers) and conserves computer resources wasted on undoing fraud for high risk virtual identifiers.

As indicated above, FIGS. 2A-2B are provided as an example. Other examples may differ from what is described in connection with FIGS. 2A-2B. For example, the machine learning model may be trained using a different process than what is described in connection with FIG. 2A. Additionally, or alternatively, the machine learning model may employ a different machine learning algorithm than what is described in connection with FIGS. 2A-2B, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 3 is a diagram of an example environment 300 in which systems and/or methods described herein may be implemented. As shown in FIG. 3, environment 300 may include a identifier manager 301, which may include one or more elements of and/or may execute within a cloud computing system 302. The cloud computing system 302 may include one or more elements 303-312, as described in more detail below. As further shown in FIG. 3, environment 300 may include a network 320, a data storage 330, an account manager 340, an event device 350, a user device 360, and/or an ML host 370. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the identifier manager 301 may include one or more elements 303-312 of the cloud computing system 302, may execute within the cloud computing system 302, and/or may be hosted within the cloud computing system 302, in some implementations, the identifier manager 301 may not be cloud-based (e.g., may be implemented outside of a cloud computing system) or may be partially cloud-based. For example, the identifier manager 301 may include one or more devices that are not part of the cloud computing system 302, such as device 400 of FIG. 4, which may include a standalone server or another type of computing device. The identifier manager 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data storage 330 may include one or more devices capable of receiving, generating, storing, processing, and/or providing information associated with (data structures encoding) events, as described elsewhere herein. The data storage 330 may include a communication device and/or a computing device. For example, the data storage 330 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data storage 330 may communicate with one or more other devices of environment 300, as described elsewhere herein.

The account manager 340 may include one or more devices capable of processing, authorizing, and/or facilitating an event (e.g., a transaction). For example, the account manager 340 may include one or more servers and/or computing hardware (e.g., in a cloud computing environment or separate from a cloud computing environment) configured to receive and/or store information associated with processing an electronic event. The account manager 340 may process an event, such as to approve (e.g., permit, authorize, or the like) or decline (e.g., reject, deny, or the like) the event and/or to complete the event if the event is approved. The account manager 340 may be associated with a financial institution (e.g., a bank, a lender, a credit card company, or a credit union). For example, the account manager 340 may be associated with an issuing bank and/or an acquiring bank (or merchant bank). The account manager 340 may communicate with one or more other devices of environment 300, as described elsewhere herein.

The event device 350 may include one or more devices capable of facilitating an electronic event. For example, the event device 350 may include a point-of-sale (PoS) terminal, a payment terminal (e.g., a credit card terminal, a contactless payment terminal, a mobile credit card reader, or a chip reader), and/or an automated teller machine (ATM). In some implementations, the event device 350 may include an access control terminal (e.g., used to control physical access to a secure area), such as an access control panel used to control an access-controlled entry (e.g., a turnstile, a door, a gate, or another physical barrier). The event device 350 may include one or more input components and/or one or more output components to facilitate interaction with a physical card and/or the user device 360. Example input components of the event device 350 include a number keypad, a touchscreen, a magnetic stripe reader, a chip reader, and/or a radio frequency (RF) signal reader (e.g., a near field communication (NFC) reader). Example output components of the event device 350 include a display and/or a speaker. The event device 350 may communicate with one or more other devices of environment 300, as described elsewhere herein.

The user device 360 may include one or more devices capable of receiving, generating, storing, processing, and/or providing information associated with (confirmation or rejection of) events, as described elsewhere herein. The user device 360 may include a communication device and/or a computing device. For example, the user device 360 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 360 may communicate with one or more other devices of environment 300, as described elsewhere herein.

The ML host 370 may include one or more devices capable of receiving, generating, storing, processing, and/or providing information associated with machine learning models, as described elsewhere herein. The ML host 370 may include a communication device and/or a computing device. For example, the ML host 370 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 370 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with dynamic modification of virtual identifiers based on machine learning. The device 400 may correspond to a data storage 330, an account manager 340, an event device 350, a user device 360, and/or an ML host 370. In some implementations, a data storage 330, an account manager 340, an event device 350, a user device 360, and/or an ML host 370 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

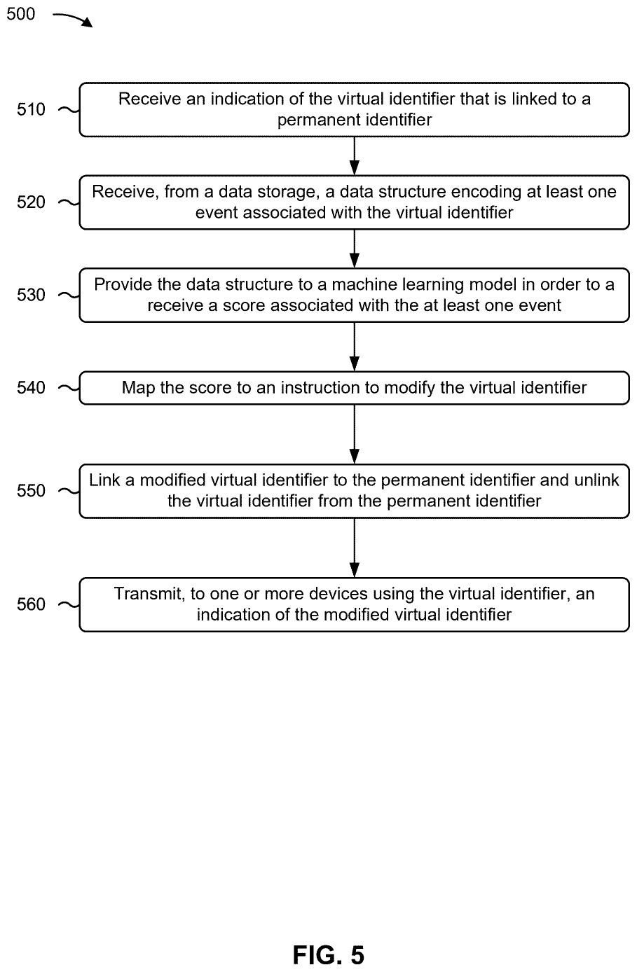

FIG. 5 is a flowchart of an example process 500 associated with dynamic modification of virtual identifiers based on machine learning. In some implementations, one or more process blocks of FIG. 5 may be performed by an identifier manager 301. In some implementations, one or more process blocks of FIG. 5 may be performed by another device or a group of devices separate from or including the identifier manager 301, such as a data storage 330, an account manager 340, an event device 350, a user device 360, and/or an ML host 370. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving an indication of a virtual identifier that is linked to a permanent identifier (block 510). For example, the identifier manager 301 (e.g., using processor 420, memory 430, input component 440, and/or communication component 460) may receive an indication of a virtual identifier that is linked to a permanent identifier, as described above in connection with FIG. 1A. As an example, the identifier manager 301 may generate the virtual identifier (e.g., using a pseudo-random number generator or another type of algorithm) and may associate the virtual identifier with the permanent identifier (and thus may receive the indication from an application executed by the identifier manager 301). Alternatively, the identifier manager 301 may receive the indication from a separate device or system (e.g., an account manager, as described herein).

As further shown in FIG. 5, process 500 may include receiving, from a data storage, a data structure encoding at least one event associated with the virtual identifier (block 520). For example, the identifier manager 301 (e.g., using processor 420, memory 430, and/or communication component 460) may receive, from a data storage, a data structure encoding at least one event associated with the virtual identifier, as described above in connection with reference number 105b of FIG. 1A. As an example, the data storage may push events to the identifier manager 301 (e.g., periodically or as new events associated with the virtual identifier are received and approved). Additionally, or alternatively, the identifier manager 301 may pull events from the data storage (e.g., periodically or in response to a request from an administrator). For example, the identifier manager 301 may transmit a request for events associated with the virtual identifier, and the identifier manager 301 may receive the data structure (encoding the at least one event) in response to the request.

As further shown in FIG. 5, process 500 may include providing the data structure to a machine learning model in order to a receive a score associated with the at least one event (block 530). For example, the identifier manager 301 (e.g., using processor 420, memory 430, and/or communication component 460) may provide the data structure to a machine learning model in order to a receive a score associated with the at least one event, as described above in connection with FIG. 1B. As an example, the identifier manager 301 may transmit a request including the data structure to an ML host associated with the machine learning model, and the identifier manager 301 may receive the score in response to the request. The machine learning model may be trained to generate the score in order to represent a risk associated with the at least one event (represented by the data structure) and/or a risk associated with the virtual identifier.

As further shown in FIG. 5, process 500 may include mapping the score to an instruction to modify the virtual identifier (block 540). For example, the identifier manager 301 (e.g., using processor 420 and/or memory 430) may map the score to an instruction to modify the virtual identifier, as described above in connection with reference number 120 of FIG. 1C. As an example, the identifier manager 301 may determine that the score satisfies a swapping threshold, and the swapping threshold may be associated with (e.g., stored with a link to) the instruction to modify the virtual identifier. In another example, the identifier manager 301 may receive the instruction from a table (or another type of relational data structure or a NoSQL database) that stores a set of instructions in association with a set of possible scores.

As further shown in FIG. 5, process 500 may include linking a modified virtual identifier to the permanent identifier and unlinking the virtual identifier from the permanent identifier (block 550). For example, the identifier manager 301 (e.g., using processor 420, memory 430, and/or communication component 460) may link a modified virtual identifier to the permanent identifier and unlink the virtual identifier from the permanent identifier, as described above in connection with FIG. 1C. As an example, the identifier manager 301 may transmit an instruction to store the modified virtual identifier in association with the permanent identifier (e.g., to the account manager, as described herein). Therefore, future requests associated with the modified virtual identifier may be approved (e.g., by detokenizing the modified virtual identifier to the permanent identifier).

As further shown in FIG. 5, process 500 may include transmitting, to one or more devices using the virtual identifier, an indication of the modified virtual identifier (block 560).

For example, the identifier manager 301 (e.g., using processor 420, memory 430, and/or communication component 460) may transmit, to one or more devices using the virtual identifier, an indication of the modified virtual identifier, as described above in connection with FIG. 1C. As an example, the identifier manager 301 may identify the device(s) using the virtual identifier and may transmit the indication to the device(s), such that any devices using the virtual identifier are informed that the virtual identifier is being replaced with the modified virtual identifier.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

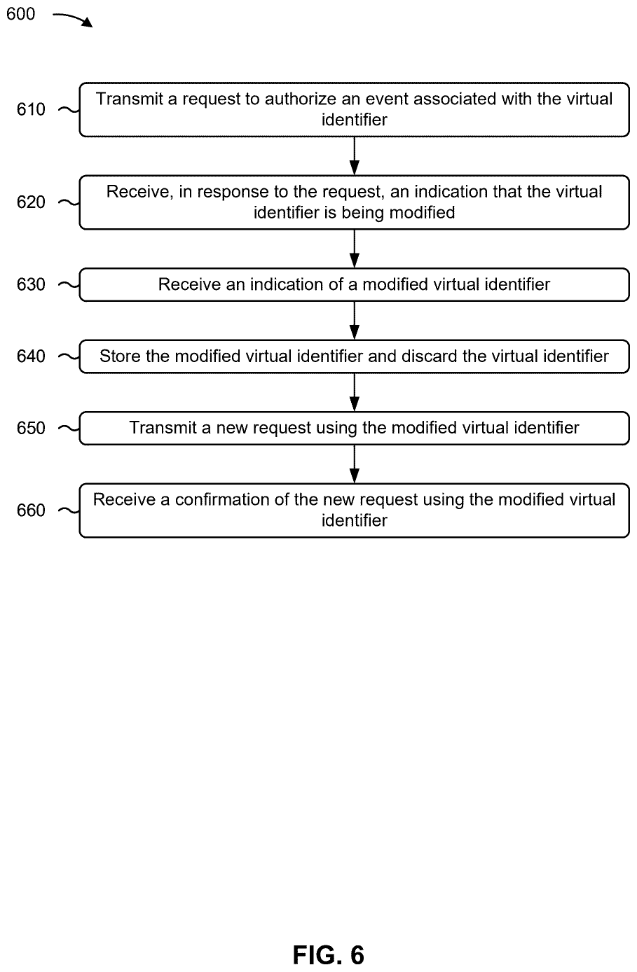

FIG. 6 is a flowchart of an example process 600 associated with receiving a dynamic modification of a virtual identifier. In some implementations, one or more process blocks of FIG. 6 may be performed by an event device 350. In some implementations, one or more process blocks of FIG. 6 may be performed by another device or a group of devices separate from or including the event device 350, such as an identifier manager 301, a data storage 330, an account manager 340, a user device 360, and/or an ML host 370. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting a request to authorize an event associated with the virtual identifier (block 610). For example, the event device 350 (e.g., using processor 420, memory 430, and/or communication component 460) may transmit a request to authorize an event associated with the virtual identifier, as described above in connection with reference number 105a of FIG. 1A. As an example, the event may be a transaction (or another type of event), and the request may include an encrypted indication of the virtual identifier. For example, the request may include a token, and the token may include an encrypted version of the virtual identifier.

As further shown in FIG. 6, process 600 may include receiving, in response to the request, an indication that the virtual identifier is being modified (block 620). For example, the event device 350 (e.g., using processor 420, memory 430, and/or communication component 460) may receive, in response to the request, an indication that the virtual identifier is being modified, as described above in connection with FIG. 1B. As an example, the event device 350 may be authorized to perform repeat events using the virtual identifier, and thus the event device 350 may be informed that the virtual identifier is being swapped out.

As further shown in FIG. 6, process 600 may include receiving an indication of a modified virtual identifier (block 630). For example, the event device 350 (e.g., using processor 420, memory 430, and/or communication component 460) may receive an indication of a modified virtual identifier, as described above in connection with reference number 130a or reference number 130b of FIG. 1C. As an example, the indication may include a token with an encrypted version of the modified virtual identifier.

As further shown in FIG. 6, process 600 may include storing the modified virtual identifier and discarding the virtual identifier (block 640). For example, the event device 350 (e.g., using processor 420 and/or memory 430) may store the modified virtual identifier and discard the virtual identifier, as described above in connection with FIG. 1C. As an example, the event device 350 may store a token that includes an encrypted version of the modified virtual identifier. The event device 350 may use the modified virtual identifier for future requests (e.g., recurring events). Additionally, in some implementations, the event device 350 may discard a token that includes an encrypted version of the virtual identifier. The event device 350 may refrain from using the virtual identifier for future requests (e.g., recurring events) because the future requests would be rejected.

As further shown in FIG. 6, process 600 may include transmitting a new request using the modified virtual identifier (block 650). For example, the event device 350 (e.g., using processor 420, memory 430, and/or communication component 460) may transmit a new request using the modified virtual identifier, as described above in connection with reference number 135a or reference number 135b of FIG. 1D. As an example, the new request may include an encrypted indication of the modified virtual identifier. For example, the new request may include a token, and the token may include an encrypted version of the modified virtual identifier.

As further shown in FIG. 6, process 600 may include receiving a confirmation of the new request using the modified virtual identifier (block 660). For example, the event device 350 (e.g., using processor 420, memory 430, and/or communication component 460) may receive a confirmation of the new request using the modified virtual identifier, as described above in connection with reference number 140a or reference number 140b of FIG. 1D. As an example, the event device 350 may output the confirmation (e.g., using output component 450) to a user.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1E. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for dynamically modifying a virtual identifier, the system comprising:
one or more memories; and
one or more processors, communicatively coupled to the one or more memories, configured to:
receive an indication of the virtual identifier that is linked to a permanent identifier, the virtual identifier including a tokenized value generated using a pseudo-random number generator or algorithm, and the permanent identifier including a secret value;
receive a data structure encoding at least one event associated with the virtual identifier;
apply a machine learning model using the data structure in order to receive a score associated with the at least one event, wherein the machine learning model is trained on information being at least one of associated with multiple virtual identifiers or applied to events associated with multiple virtual identifiers, or on information being at least one of unique to the virtual identifier or applied to events associated with the virtual identifier;
map the score to an instruction to modify the virtual identifier and to a restriction to apply;
generate a modified virtual identifier using a pseudo-random number generator or algorithm;
link the modified virtual identifier to the permanent identifier and unlink the virtual identifier from the permanent identifier;
transmit, to one or more devices using the virtual identifier, an indication of the modified virtual identifier; and
apply the restriction to the modified virtual identifier.

2. The system of claim 1, wherein the one or more processors, to receive the data structure encoding the at least one event, are configured to:
receive a request to authorize the at least one event, wherein the request comprises the data structure.

3. The system of claim 2, wherein the one or more processors are configured to:
transmit a confirmation of the at least one event in response to the request.

4. The system of claim 1, wherein the one or more processors, to map the score to the instruction to modify the virtual identifier, are configured to:
determine that the score satisfies a swapping threshold,
wherein the swapping threshold is associated with the instruction to modify the virtual identifier.

5. The system of claim 1, wherein the one or more processors, to map the score to the restriction to apply, are configured to:
determine the restriction using a table that stores a set of restrictions in association with a set of possible scores.

6. The system of claim 1, wherein the one or more processors, to link the modified virtual identifier to the permanent identifier, are configured to:
transmit, to an account manager, an instruction to store the modified virtual identifier in association with the permanent identifier.

7. A method of dynamically modifying a virtual identifier, comprising:
receiving, at an identifier manager, an indication of the virtual identifier that is linked to a permanent identifier, the virtual identifier including a tokenized value generated using a pseudo-random number generator or algorithm, and the permanent identifier including a secret value;
receiving, from a data storage, a data structure encoding at least one event associated with the virtual identifier;
applying a machine learning model using the data structure in order to receive a score associated with the at least one event, wherein the machine learning model is trained on information being at least one of associated with multiple virtual identifiers or applied to events associated with multiple virtual identifiers, or on information being at least one of unique to the virtual identifier or applied to events associated with the virtual identifier;
mapping, by the identifier manager, the score to an instruction to modify the virtual identifier;
generating, by the identifier manager, a modified virtual identifier using a pseudo-random number generator or algorithm;
linking, by the identifier manager, the modified virtual identifier to the permanent identifier and unlinking the virtual identifier from the permanent identifier; and
transmitting, from the identifier manager and to one or more devices using the virtual identifier, an indication of the modified virtual identifier.

8. The method of claim 7, further comprising:
transmitting, to the data storage, a request for events associated with the virtual identifier,
wherein the data structure is received in response to the request.

9. The method of claim 7, wherein mapping the score to the instruction to modify the virtual identifier comprises:
receiving the instruction from a table that stores a set of instructions in association with a set of possible scores.

10. The method of claim 7, wherein applying the machine learning model comprises:
transmitting, to a machine learning host associated with the machine learning model, a request including the data structure,
wherein the score is received from the machine learning host in response to the request.

11. The method of claim 7, wherein unlinking the virtual identifier from the permanent identifier comprises:
transmitting, to an account manager, an instruction to disassociate the virtual identifier from the permanent identifier.

12. The method of claim 7, wherein the machine learning model is unique to the virtual identifier.

13. The method of claim 7, further comprising:
identifying the one or more devices, using the virtual identifier, from a list of devices associated with the permanent identifier.

14. The method of claim 7, further comprising:
receiving, from an account manager, an indication of the one or more devices using the virtual identifier.

15. A non-transitory computer-readable medium storing a set of instructions for receiving a dynamic modification of a virtual identifier, the set of instructions comprising:
one or more instructions that, when executed by one or more processors of a device, cause the device to:
transmit a request to authorize an event associated with the virtual identifier, the request including a data structure encoding the event and including an encrypted indication of the virtual identifier, the virtual identifier including a tokenized value generated using a pseudo-random number generator or algorithm and linked to a permanent identifier comprising a secret value, wherein the event is recurring;
receive, in response to the request, an indication that the virtual identifier is being modified;
receive an indication of a modified virtual identifier generated using a pseudo-random number generator or algorithm and linked to the permanent identifier;
store the modified virtual identifier and discard the virtual identifier;
transmit a new request using the modified virtual identifier; and
receive a confirmation of the new request using the modified virtual identifier.

16. The non-transitory computer-readable medium of claim 15, wherein the one or more instructions, when executed by the one or more processors, cause the device to:
transmit, to a user device, instructions for a user interface indicating a portion of the permanent identifier associated with the virtual identifier and the modified virtual identifier.

17. The non-transitory computer-readable medium of claim 15, wherein the request includes an encrypted indication of the virtual identifier.

18. The non-transitory computer-readable medium of claim 15, wherein the new request includes an encrypted indication of the modified virtual identifier.

19. The non-transitory computer-readable medium of claim 15, wherein the one or more instructions, that cause the device to store the modified virtual identifier, cause the device to:
store a token that includes an encrypted version of the modified virtual identifier.

20. The non-transitory computer-readable medium of claim 15, wherein the one or more instructions, that cause the device to discard the virtual identifier, cause the device to:
discard a token that includes an encrypted version of the virtual identifier.
